(19) United States
(12) Patent Application Publication
(10) Pub. No.: US 2017/0267506 A1
(43) Pub. Date: Sep. 21, 2017

(54) TILLER HEAD FOR A PEDESTRIAN AND RIDER FORKLIFT

(71) Applicant: GEBRÜDER FREI GMBH & CO. KG, 72461 Albstadt-Onstmettingen (DE)

(72) Inventors: THOMAS FREI, Albstadt (DE); HERIBERT SCHLEGEL, Balingen (DE)

(73) Assignee: GEBRÜDER FREI GMBH & CO. KG, 72461 Albstadt-Onstmettingen (DE)

(21) Appl. No.: 15/310,353

(22) PCT Filed: Mar. 5, 2015
(86) PCT No.: PCT/EP2015/000496

§ 371 Date: Nov. 10, 2016

(30) Foreign Application Priority Data
May 14, 2014 (DE) 10 2014 007 078.6

(51) Int. Cl. B66F 9/20; B62D 1/14; B66F 9/075

(52) U.S. Cl. CPC B66F 9/20; B66F 9/07568; B62D 1/14

(57) ABSTRACT

A tiller head for a pedestrian and rider forklift includes an upper cover and operating elements, which are connected to a control device to execute a desired operation command execution. The control device is a functionally ready prepared unit for all functions of the respectively desired operation command execution. The control device is arranged at a central point in the tiller head and is constructed such that the operating elements directly engage elements in the control device in a form-fitting manner during installation.

The present invention relates to a tiller head for a pedestrian and rider forklift with operating units for the traction drive, the raising and lowering of the load-carrying member, honking and crawl speed.

A tiller head, as shown for example in DE 10 2006 008 038 A1, includes a middle section (a horn) connectable to a tiller handle, rod-like grip portions arranged on both sides of the horn and substantially running transversely, a traction switch grip rotatably mounted on the horn, at least two switch buttons on each side of the horn, and a body safety switch which is arranged on the free end of the horn in opposition to the handle end. The operating elements provided on the tiller head are wired to control elements in the housing of the tiller head in order to cause a raising and lowering of the load-carrying member, a honking or a crawl speed, by transmitting operating signals to the corresponding points on the pedestrian and rider forklift, for example, a motive drive.

A cabling with many cables in the housing of the tiller head is cumbersome during initial installation. If there is no precise identification of individual cables during initial installation, there may be difficulties with a possibly upcoming repair. In addition, the space requirement is increased for individual cables in the housing of the tiller head.

It is therefore the object of the invention to improve a tiller head for pedestrian and rider forklifts with operating units such that a cabling of operating units in a housing of the tiller head is less cumbersome than heretofore.

This object is achieved by a tiller head as set forth in independent patent claim 1. The dependent claims 2 to 7 set forth advantageous refinements of the present invention.

The tiller head according to the invention for a pedestrian and rider forklift has an upper cover which is provided with operating elements that are connected to a control device for the execution of a desired operation command execution. In particular, the control device is a functionally ready prepared unit for all functions of the desired operation command executions. The control device is provided at a central area in the tiller head and constructed such that the operating elements directly engage elements of the control device in a form-fitting manner during installation.

As a result of the particular design of the control device, which conforms to the tiller head with its operating elements, the control device can be installed easily and is ready for use without additional programming. It functions according to the Plug & Play principle.

Preferably, the control device has a communication connection to a vehicle or industrial truck by means of a CAN connection. A particularly easy installation of the control device is possible by using the CAN connection.

It is particularly preferred, when the control device has non-contact sensors. This advantageously eliminates cabling.

A further advantage is that the control device is designed tightly sealed and as a result protects the moisture-sensitive electronics. Easy use of the tiller head according to the invention is possible in harsh environmental conditions.

In particular, the operating elements have levers for the motive drive, a stop button, a snap-fit rocker for a continuous crawl speed, buttons for honking, buttons for raising and lowering a load-carrying member, and a button for selecting forward or reverse travel. All operating elements are arranged to conform to the control device such as to directly engage elements of the control device in a form-fitting manner during installation. Simple installation and assembly are thus possible.

The specified and further features and details of the invention will become more apparent to one skilled in the art from the following detailed description and the accompanying drawings, which illustrate features of the present invention by way of example and wherein it is shown in

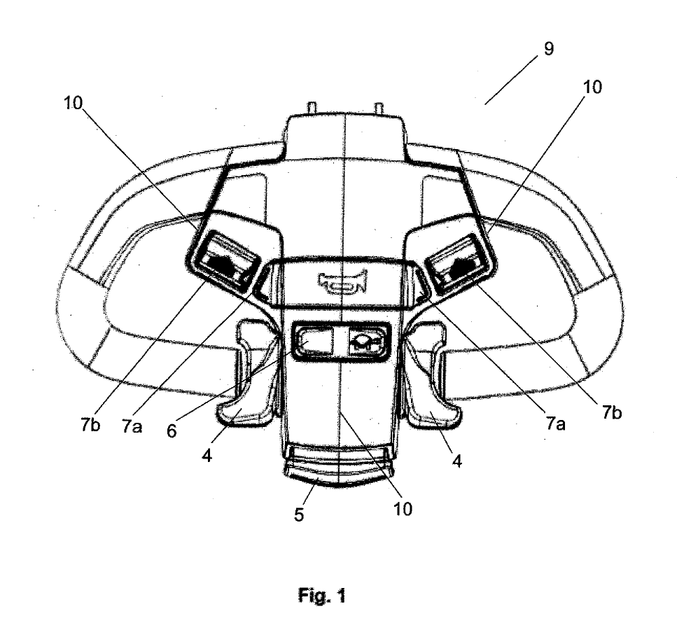

FIG. 1 a plan view of a tiller head according to the invention,

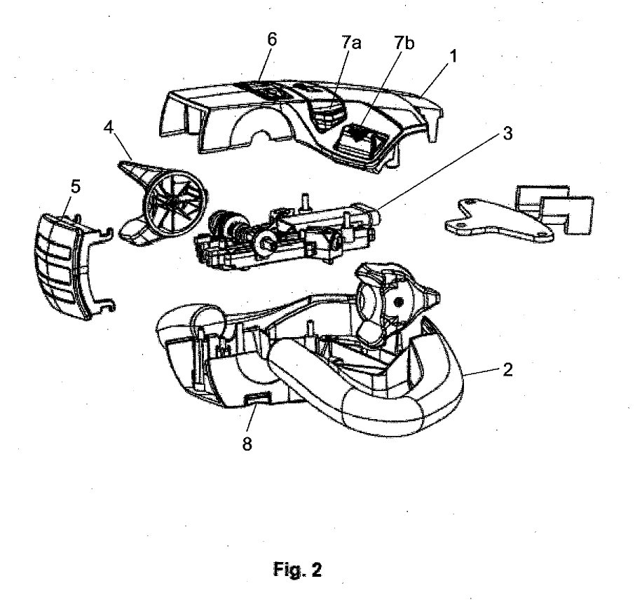

FIG. 2 an exploded view of the tiller head according to the invention,

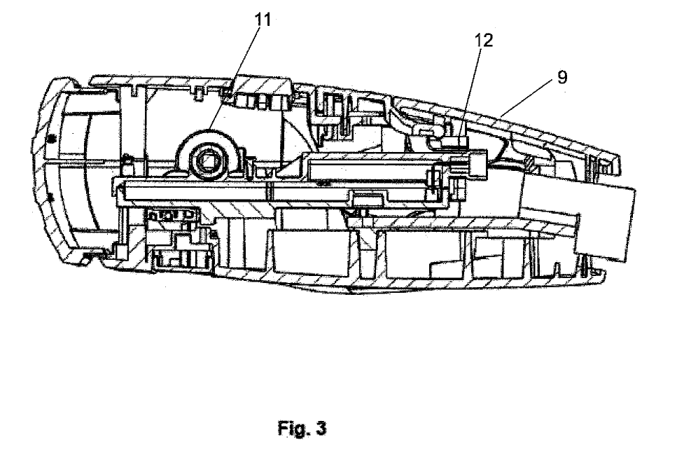

FIG. 3 a side sectional view of the tiller head according to the invention,

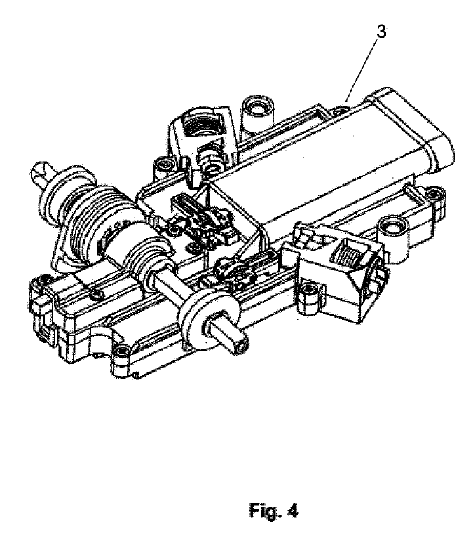

FIG. 4 an oblique view of a control device for the tiller head according to the invention from above,

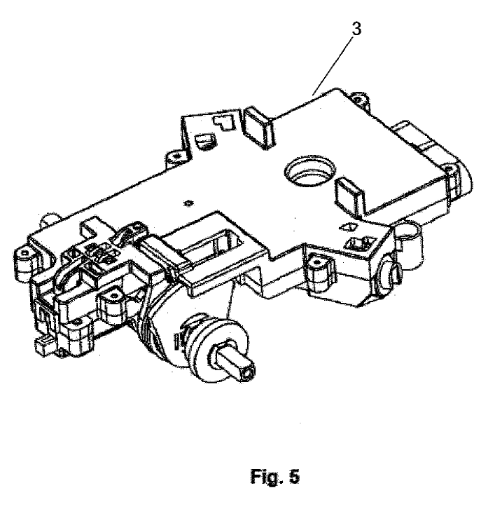

FIG. 5 an oblique view of the control device for tiller head according to the invention from below,

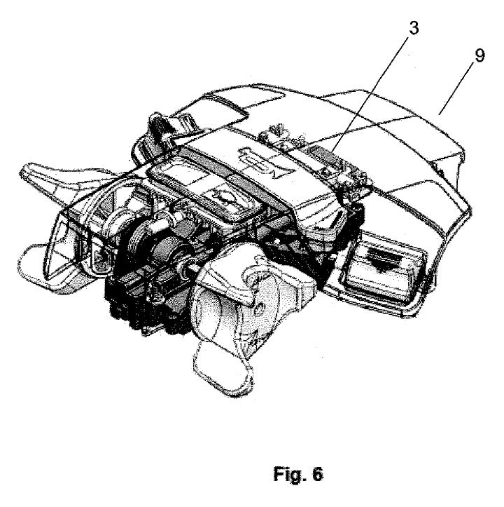

FIG. 6 a cutaway oblique view of the tiller head according to the invention with built-in control device from above, and

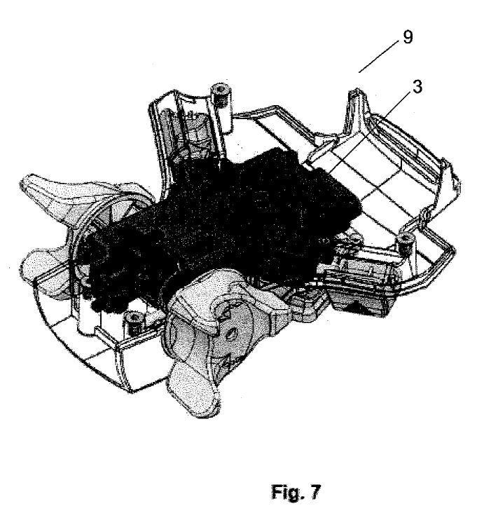

FIG. 7 a cutaway oblique view of the tiller head according to the invention with built-in control device from below.

FIG. 1 shows a plan view of a tiller head 9 according to the invention with horn and grip portions. FIG. 1 shows at the top the connecting point on the horn of the tiller head 9 to the drawbar and at the bottom a stop button 5 on the horn of the tiller head 9. The tiller head 9 is furthermore provided with levers 4 on the grip portions, a snap-fit rocker 6 centrally on the horn and buttons 7a, 7b on the side on the horn for various operating functions of the tiller head 9.

In particular, the levers 4 serve as traction switch. The snap-fit rocker 6 is used to actuate an element of a control device 3 shown, for example, in FIG. 2, to induce, for example, a continuous crawl speed. The buttons 7a, provided on both sides of the horn of the tiller head 9, are used to honk and the buttons 7b, provided both sides of the horn of the tiller head 9, are used to raise and lower a load-carrying member.

In FIG. 1, rotation axes 10 of the tiller head 9 can also be seen.

FIG. 2 shows an exploded view of the tiller head 9 according to the invention, wherein in addition to the levers 4, the stop button 5, the snap-in rocker 6 and the buttons 7a, 7b for various operating functions which are already shown in FIG. 1, a button 8 can be seen at the underside of the horn of the tiller head 9, which button has an operating function to select, for example, a travel with reduced speed.

The structure of the tiller head 9 according to the invention with upper cover I and drawbar bottom shell 2 as housing parts to form a snugly closed housing is readily apparent from FIG. 2. It is readily apparent that a control device 3 is provided at a central point in the tiller head 9. The control device 3 has a communication connection to the vehicle or industrial truck via a CAN connection. A functionally ready prepared unit is provided with non-contact sensors and can be installed as a component or spare part in the tiller head 9 and is ready for use without further programming. The control device 3 is designed such that the levers 4, the stop button 5, the snap-in rocker 6, the buttons 7a and 7b, and the button 8 directly engage corresponding elements of the control device 3 in a form-fitting manner during installation.

FIG. 3 shows a side sectional view of the tiller head 9 according to the invention, wherein the built-in control device 3, in particular with a traction switch axle 11 and an electrical interface 12, is shown for connection to a drawbar.

FIGS. 4 and 5 show each an oblique view of the control device 3 of the tiller head 9 according to the invention from above and from below, wherein the structure with elements for a direct form-fitting engagement with the levers 4, the stop button 5, the snap-in rocker 6, the buttons 7a and 7b, and the button 8 during installation is readily apparent.

FIGS. 6 and 7 show each a cutaway oblique view of the tiller head 9 according to the invention with built-in control device 3 from above and from below, wherein the manner of direct engagement in a form-fitting manner of the levers 4, the stop button 5, the snap-in rocker 6, the buttons 7a and 7b, and the button 8 in corresponding elements of the control device 3 during installation is readily apparent.

In accordance with the invention, a tiller head for a pedestrian and rider forklift is thus provided that is modularly constructed through a special design of the control device. By conforming to the tiller head with its operating elements, the control device can be installed in a simple manner and is advantageously ready for use without further programming.

What is claimed is:

1.-7. (canceled)

8. A tiller head for a pedestrian and rider forklift, said tiller head comprising:
an upper cover having operating elements; and
a control device, said operating elements being connected to the control device to execute operation commands, said control device being a functionally ready-for-use unit to execute all functions of the operation commands, said control device being arranged at a central point in the tiller head and constructed such that the operating elements directly engage elements in the control device in a form-fitting manner during installation.

9. The tiller head of claim 8, wherein the control device has a communication connection with a vehicle or industrial truck via a CAN connection.

10. The tiller head of claim 8, wherein the control device has non-contact sensors.

11. The tiller head of claim 8, wherein the control device is designed tightly sealed.

12. The tiller head of claim 8, wherein the operating elements involve levers for a motive drive, a stop button, a snap-in rocker for selecting a speed level, first buttons for horns, second buttons for raising and lowering a load-carrying member, and a third button for selecting a temporary crawl speed.

13. The tiller head of claim 8, wherein one of the operating elements is a horn and other ones of the operating elements are levers for a motive drive, said horn being configured to enable comfortable actuation thereof when simultaneously operating the levers.

14. The tiller head of claim 8, further comprising a drawbar bottom shell, said upper cover together with the drawbar bottom shell forming a housing of the tiller head.
